(19) United States
(12) Patent Application Publication
(10) Pub. No.: US 2025/0166984 A1
(43) Pub. Date: May 22, 2025

(54) FREQUENCY DECOUPLING IN DYNAMIC FLUIDIC ANALYSIS AND ACOUSTIC DROPLET EJECTION

(71) Applicant: Labcyte Inc., San Jose, CA (US)

(72) Inventors: Chang Liu, Richmond Hill (CA); Jing Ma, Singapore (SG); Heguang Ji, Singapore (SG); Stephen Hinkson, San Carlos, CA (US); Christian Miller, San Jose, CA (US); Xu Du, San Jose, CA (US)

(73) Assignee: Labcyte Inc., San Jose, CA (US)

(21) Appl. No.: 18/934,048

(22) Filed: Oct. 31, 2024

Related U.S. Application Data
(60) Provisional application No. 63/594,739, filed on Oct. 31, 2023.

(51) Int. Cl. H01J 49/04; H01J 49/16

(52) U.S. Cl. CPC H01J 49/0445; H01J 49/165

(57) ABSTRACT

Systems and methods are disclosed herein that prevent over-production of acoustically ejected droplets into a mass spectrometer, without increase to the time required to conduct pre-ejection sample analysis. This is accomplished by decoupling the repetition rate of energy pulses delivered to the sample during an analysis mode from the repetition rate of energy pulses delivered to the sample during ejection mode. The repetition rate during analysis is higher than the repetition rate used during droplet ejection, which is reduced to a level that can be ingested by the acoustically emitted mass spectrometry system.

### CROSS-REFERENCE RELATED APPLICATION(S)

This application claims the benefit of priority to U.S. Provisional Application No. 63/594,739, filed Oct. 31, 2023, the disclosure of which is hereby incorporated by reference in its entirety.

### BACKGROUND

In the acoustic droplet ejection (ADE) process, the acoustic energy used for the ejection can be optimized through by emitting an acoustic signal into the sample and measuring the reflected wave. One such ADE optimization process is referred to as dynamic fluidic analysis (DFA) process. In DFA, the acoustic echoes from the sample liquid-air interfaces are measured to detect variation of mound height during a series of multiple-step power increases. The duration of DFA is related to the repetition rate (referred to herein as reprate) between these power increases. By monitoring mound height, the amount of energy required to eject a droplet with a desired size and momentum can be determined. In a typical DFA process, a reprate may be several hundred Hz and there can be between 10 and 50 cycles, resulting in the duration of DFA ˜100 ms.

With DFA or other acoustic analysis of the condition of the sample complete, a conventional ADE process begins emitting sample droplets by emitting the required acoustic energy into an open port interface (OPI). When an ADE device and OPI are coupled to a mass spectrometer, the system can be referred to as an acoustic ejection analyzer system, such as an acoustic ejection mass spectrometry (AEMS) system. High throughput from the ADE to the OPI is desirable in a typical AEMS system, as it results in higher speed and efficiency, increased data acquisition, and improved sensitivity.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

In a first aspect, a method is disclosed for acoustic dispensing of a train of droplets from a sample in a well. The method includes emitting a plurality of analysis pulses at an analysis repetition rate into the sample, determining a condition of the sample based upon a reflected pulse, wherein the reflected pulse is based upon one of the plurality of analysis pulses after reflection at the sample, and determining a droplet ejection repetition rate based upon a preselected rate. The method further includes emitting an acoustic ejection signal into the sample at the droplet ejection repetition rate that is lower than the analysis repetition rate.

The method can include emitting the acoustic ejection signal in wide peak mode. Emitting the acoustic ejection signal into the sample at the droplet ejection repetition rate can include ejecting the droplet to generate a desired analysis signal output profile based upon a maximum OPI ingestion rate. The analysis repetition rate is in a range of 10 Hz and 100 KHz. In another example, the analysis repetition rate is in a range of 80 Hz and 240 Hz, while the ejection repetition rate is less than 80 Hz. The analysis repetition rate can be equal to about 160 Hz. The ejection repetition rate can be a range of 5 Hz to 15 Hz, such as about 10 Hz.

According to another aspect disclosed herein, a system for delivering a sample from a well includes an acoustic transducer, a sample droplet receiver, a mass analysis device, an input device, and a processor. The processor can be operatively coupled to the sample droplet receiver, the mass analysis device, the acoustic transducer, and the input device. A memory can be coupled to the processor, the memory storing instructions that, when executed by the processor, perform a set of operations. Those operations include performing, via the acoustic transducer, an analysis of the sample in the well at an analysis repetition rate to determine a condition of the sample, receiving, at the input device, a droplet ejection repetition rate, and ejecting, via the acoustic transducer, the droplet at the received droplet ejection repetition rate. The analysis repetition rate is different than (and higher than) the ejection repetition rate. The processor can further cause the system to terminate the dynamic fluid analysis based at least in part on the determined condition of the sample.

In the system, ejecting the droplet at the received droplet ejection repetition rate can include emitting acoustic pulses corresponding to a wide peak mode setting. The set of instructions can include ejecting the droplet at the received ejection repetition rate to generate a desired analysis signal output profile based upon a maximum OPI ingestion rate. The analysis repetition rate can be in a range of 10 Hz and 100 KHz. In another example, the analysis repetition rate can be in a range of 80 Hz and 240 Hz and the ejection repetition rate can be less than 80 Hz. The analysis repetition rate can be equal to about 160 Hz. The ejection repetition rate can be a range of 5 Hz and 15 Hz, such as 10 Hz.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view of an example system combining acoustic droplet ejection (ADE) with an open port interface (OPI) sampling interface and electrospray ionization (ESI) source.

FIG. 2 shows a schematic of a system for sample preparation and analysis.

FIG. 3 shows an alternative schematic of a system for sample preparation and analysis.

FIG. 4A shows a sample during an unperturbed stage.

FIG. 4B shows the sample of FIG. 4A during an analysis stage.

FIG. 4C shows the sample of FIG. 4A during an ejection stage.

FIG. 5 is a chart of energy delivered to a sample as a function of time according to a reprate-decoupled droplet ejection method.

FIG. 6 illustrates a combined intensity peak, in accordance with various aspects and examples of the present disclosure.

FIG. 7 depicts an example of a suitable operating environment in which one or more of the present examples can be implemented.

FIG. 8 is a method for producing a sample using decoupled analysis and droplet ejection repetition rates.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Examples of the present disclosure generally relate to systems and methods for analyzing a collection of substance samples using an analyzer. Conventionally, the preparation and introduction of sample into an analyzer, such as a mass spectrometer, is a relatively time-consuming process, particularly where rapid and efficient analysis of a sample pool containing multiple samples, which may or may not be analytically related, is desired. A liquid handling system can be used for preparation of samples, an ejection system can be used for ejecting samples into a port or interface, and an analyzer can be used for the analysis of the samples. Each system can be controlled and operated in concert to analyze a sample.

This application is generally applicable to a variety of analyzers and analyzer systems. One example of an analyzer is a mass spectrometer. For ease of explanation, aspects of the present disclosure are sometimes described with reference to examples involving mass spectrometry and mass spectrometers. However, it is appreciated that a mass spectrometer is just one possible example. Accordingly, such examples described herein are also applicable to other analyzers or analyzer systems.

As described in more detail with respect to the drawings below, it has been recognized that decoupling the reprate used in sample analysis from the reprate used for droplet ejection can be beneficial in some contexts. Specifically, it has been recognized that in wide peak mode, using a high analysis reprate may be desirable to rapidly determine the ejection energy level or other characteristics of the sample, but using that same reprate for droplet ejection can cause sufficient liquid volume to be ejected to cause dripping, cross-contamination, or other undesirable effects. By decoupling the analysis reprate from the droplet ejection reprate, and by reducing the latter of these to a level that can be ingested by the OPI, an appropriate level of aerosol flow can be provided for analysis while maintaining low sample analysis times. This decoupling and lowering of the ejection reprate can be particularly useful for wide peak mode droplet ejection.

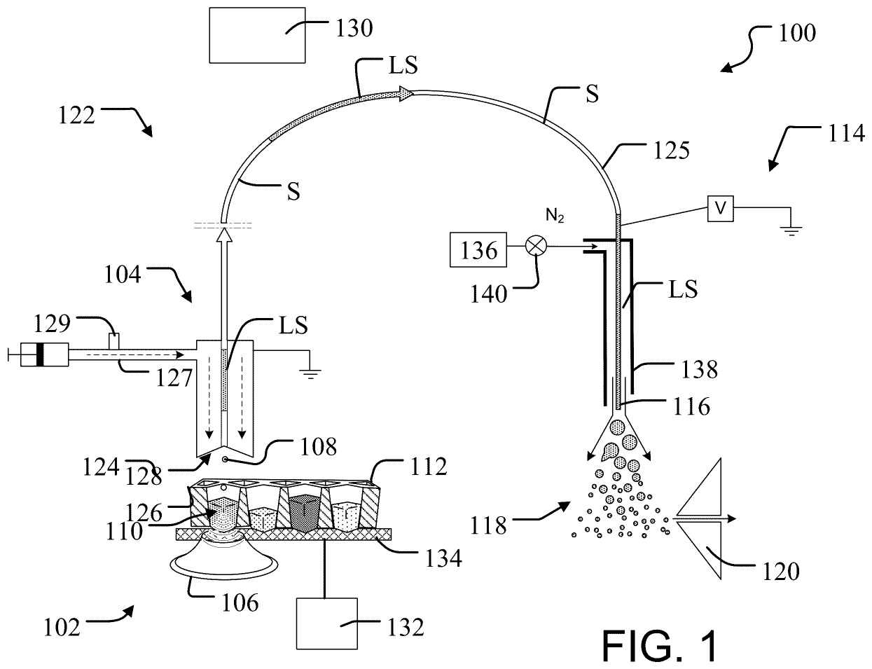

FIG. 1 is a schematic view of an example system 100 combining an ADE 102 with an OPI sampling interface 104 and electrospray ionization (ESI) source 114. The system 100 may be an analyzer. An example of an analyzer is a mass analysis instrument such as a mass spectrometry device that is for ionizing and mass analyzing analytes received within an open end of a sampling OPI. Such a system 100 is described, for example, in U.S. Pat. No. 10,770,277, the disclosure of which is incorporated by reference herein in its entirety.

The ADE 102 includes an acoustic ejector 106 that is configured to provide acoustic emission into each of the reservoirs 112. This acoustic signal can be used either to conduct analysis of the sample in the reservoir 112, or to eject a droplet 108 from a reservoir 112 into the open end of sampling OPI 104, as will be described in more detail below.

As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are in the gas phase.

A liquid handling system 122 (e.g., including one or more pumps 124 and one or more conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. A test liquid interface 129 is also depicted coupled to the supply conduit 127. As discussed in detail below, the flow of liquid into and out of the sampling OPI 104 occurs within a sample space accessible at the open end such that one or more droplets 108 can be introduced into the liquid boundary 128 at the sample tip and subsequently delivered to the ESI source 114.

The system 100 includes an ADE 102 that is configured to generate acoustic energy that is applied to a liquid contained within a reservoir 110 that causes one or more droplets 108 to be ejected from the reservoir 110 into the open end of the sampling OPI 104. A controller 130 can be operatively coupled to the ADE 102 and can be configured to operate any aspect of the ADE 102 (e.g., focusing structures, acoustic ejector 106, automation elements 132 for moving a movable stage 134 so as to position a reservoir 110 into alignment with the acoustic ejector 106, etc.). This enables the ADE 106 to inject droplets 108 into the sampling OPI 104 as otherwise discussed herein substantially continuously or for selected portions of an experimental protocol by way of non-limiting example. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g. nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include discrete volumes of liquid samples LS received from each reservoir 110 of the well plate 112. The discrete volumes of liquid samples LS are typically separated from each other by volumes of the solvent S (hence, as flow of the solvent moves the liquid samples LS from the OPI 104 to the ESI source 114, the solvent may also be referred to herein as a transport liquid). The nebulizer gas can be supplied at a variety of flow rates, for example, in a range from about 0.1 L/min to about 20 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector coupled to the mass analyzer orifice 120 depicted in FIG. 1 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference between in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

During use of the mass spectrometry device of FIG. 1, the delay time between acoustic ejections affects the throughput rate for analysis of a set of samples, such as samples in a well plate. Accordingly, by changing the delay time between ejections (which may be acoustic ejections, drop-on-demand ejections, etc.), the throughput rate can be modified. The ejections tested in the present application may be a single droplet ejection from a single well or repeated ejections from the same well. Such ejections (single or multiple) result in a single signal peak in the mass spectrometry analysis.

It can be desirable in some circumstances to reduce the throughput from the OPI to a rate that is based upon the amount that can be accepted either by the liquid handling system 122 or the mass analyzer detector 120. An example of such a context is in the use of wide peak mode for the AEMS system. “Wide peak mode” refers to an operational mode of the OPI that allows the mass spectrometer to capture a broader range of mass-to-charge values and may require a long signal duration if many ions are required to be analyzed in the mass spectrometer per pulse. As described above, the flow of liquid into and out of the sampling OPI 104 occurs within a sample space accessible at the open end such that one or more droplets 108 can be introduced into the liquid boundary 128 at the sample tip and subsequently delivered to the ESI source 114, but in some instances during wide peak mode the droplets 108 can exceed the intake capacity at the liquid boundary 128.

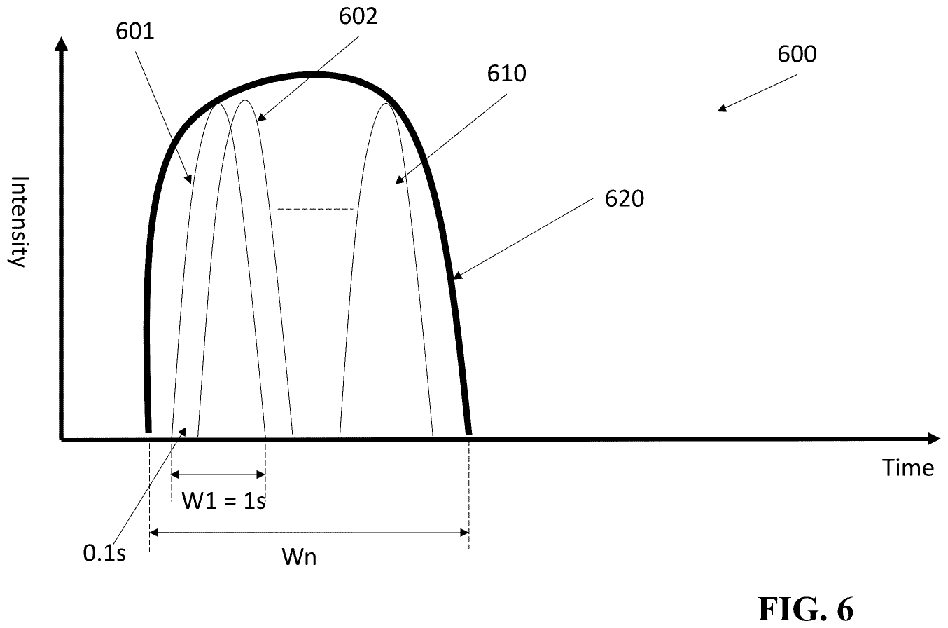

In conventional mass spectrometry, data is acquired by scanning through a range of mass-to-charge ratios to detect and quantify ions of interest. The width of the mass range that can be captured during each scan is determined by the instrument's settings. “Wide peak mode,” in contrast, extends the mass range of each scan by extending the droplet-ejection pulses in the time domain, with a longer signal duration that can be up to several seconds in common usage. This can be beneficial in certain applications, especially when there is a need to analyze a wide range of analytes with different mass values quickly. It can increase the efficiency and throughput of the mass spectrometry analysis by reducing the time required to scan through the entire mass range of interest. Wide peak mode is described in more detail below with respect to FIG. 6.

In wide peak mode, the reprate used for droplet ejection frequency should not be set too high for handling by the OPI. Especially in the wide peak mode, there are risks of sample dripping at high droplet ejection frequency. This could cause inaccurate readings across multiple samples and cross-contamination therebetween. On the other hand, slowing the reprate used for analysis of the sample leads to longer analysis or sample characterization times. Therefore it is advantageous to decouple these two rates, and to set the reprate for analysis as high as possible while reducing the reprate for droplet ejection lower, and no higher than the highest rate that can be handled by the overall AEMS system. By decoupling the reprate of analysis and ejections, customers and perform wide peak ejections without incurring unexpected throughput loss.

The systems provided in the present disclosure advantageously include a central control system that is able to control the underlying subsystems used in the sample analysis process. For example, a script or set of operations may be generated at the central control system or controller that allows for control of the subsystems such that the subsystems are able to work synchronously across different types of operations performed by each of the subsystems. To accomplish such synchronicity across the subsystems, additional mechanical devices, such as robotics, may be incorporated into the overall system to handle transitions of materials between the systems. Thus, the central controller is able to interface with the various subsystems and transition robotics to more efficiently control each of the operations performed by the subsystems.

Furthermore, the present systems may include a computing subsystem and various functional modules thereof configured to efficiently process the data generated from multiple samples, reliably determine the data-sample correlation for a large pool of samples, generate mass spectra for each test sample, analyze the generated mass spectra, and provide real-time feedback to other subsystems.

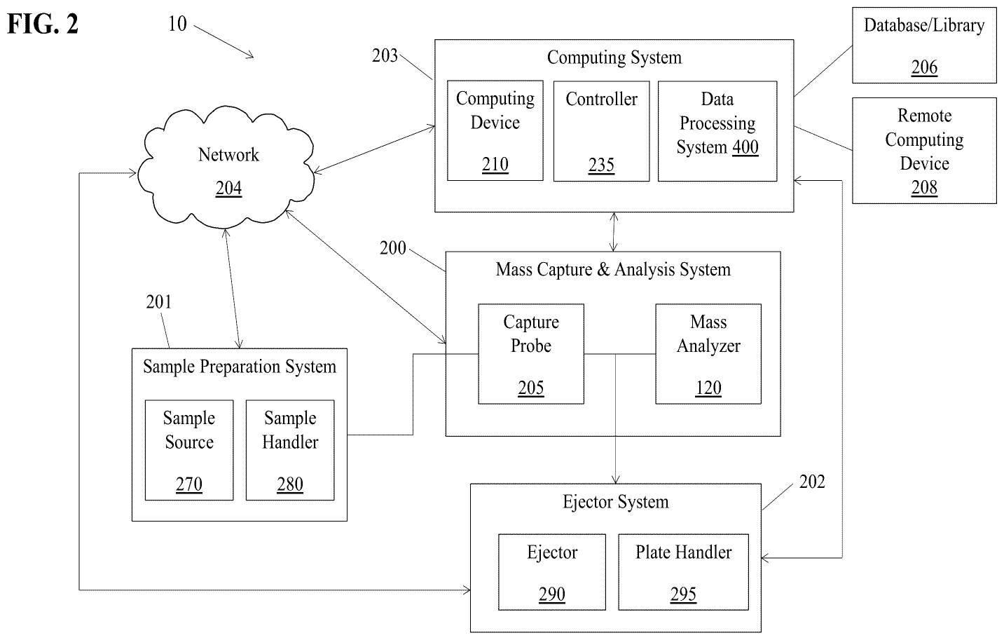

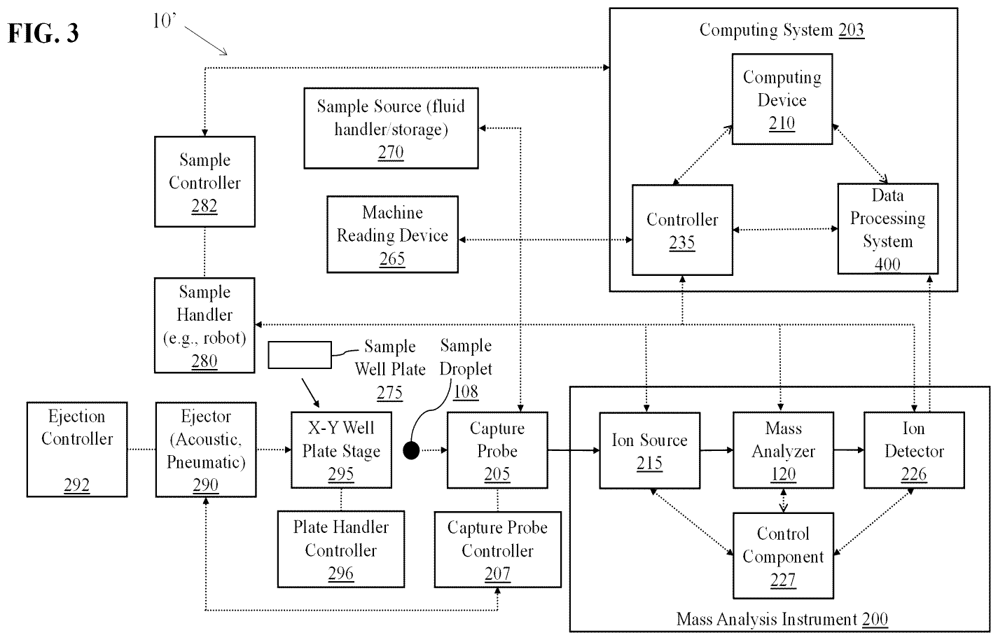

Referring to FIGS. 2 and 3, examples of systems that decouple the analysis and sample ejection reprates are illustrated and described. In the illustrated examples, the system 10 or 10′ can each include, in various combinations, pluralities of components, including some or all of: a mass capture and analysis system 200, a sample preparation system 201, an ejector system 202, a computing system 203, a network 204, a database/library 206, and a remote computing device 208. In the example illustrated in FIG. 2, various systems 200, 201, 202, 203, 204, and 206 are subsystems of the system 10 and may be operably connected between or among each other. For example, the computing system 203 is in bilateral communication with the mass capture and analysis system 200, and is also in bilateral communication with the ejector system 202; the sample preparation system 201 is in communication with the mass capture and analysis system 200, and is also in communication with the ejector system 202; the mass capture and analysis system 200 is in communication with the ejector system 202; and the database 206 and the remote computing device 208 are each in communication with the computing system 203.

In some examples, the mass capture and analysis system 200 may be a mass analysis instrument 200. The mass capture and analysis system 200 may be a mass spectrometer system including a mass analyzer 120 for analyzing ions generated from ionization of a sample. The mass capture and analysis system 200 may also include a capture device or probe 205 that captures the sample and provides the sample to other components of the mass capture and analysis system 200. In other examples (such as shown in FIG. 3), the capture probe 205 may be located externally from the mass analysis instrument 200. For instance, the capture probe 205 may be part of the ejection system 202.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 215. By way of non-limiting example, the mass analyzer 120 can be a triple quadrupole mass spectrometer, or any other mass analyzer known in the art and modified in accordance with the teachings herein. Other non-limiting, example mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer” (James W. Hager and J. C. Yves Le Blanc; Rapid Communications in Mass Spectrometry; 2003; 17:1056-1064); and U.S. Pat. No. 7,923,681, the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, time-of-flight (ToF), trap, and hybrid analyzers. It will further be appreciated that any number of additional elements can be included in the system 200 including, for example, an ion mobility spectrometer (e.g., a differential mobility spectrometer) that is disposed between the ionization source 215 and the mass analyzer detector 120 and is configured to separate ions based on their mobility difference between in high-field and low-field). Additionally, it is appreciated that the mass analyzer 120 can include a detector 226 that can detect the ions that pass through the analyzer 120 and can, for example, supply a signal indicative of the number of ions per second that are detected.

The sample preparation system 201 may include a sample source 270 and a sample handler 280. The sample source 270 and a sample handler 280 are operative to retrieve collections of samples from the sample source(s) and to deliver the retrieved collections to capture locations associated with sample capture probes 205. The systems may be operative to independently capture selected ones of the pluralities of samples at the capture locations from the pluralities of samples, to optionally dilute the samples and to transfer the captured samples to mass analysis instruments 200, 120 for mass analysis. In some examples, the sample source 270 may include a set of well plates in a storage housing and/or liquid for adding to well plates. The sample source 270 may include part of a liquid handling system that manipulates and/or injects liquid into the well plates. The sample handler 280 includes one or more electro-mechanical devices (e.g., robotics, conveyor belts, stages, etc.) that are capable of transferring the samples (e.g., well plates) from the sample source to other components of the sample preparation system 201 and/or to other systems, such as the ejection system 202 and/or the capture probe 205. As an example, the sample handler 280 may transfer a well plate from the sample preparation system 201 to the ejection system 202. More specifically, the sample handler 280 may transfer the well plate to a plate handler 295 of the ejection system 202. Accordingly, the sample preparation system 201 may also be referred to as a sample delivery system. In some examples, selected sample information (e.g. sample or compound ID, chemical structure of the target compound, or other sample information) could be obtained during the sample handling steps through the use of sample controller 82 and/or the sample handler 280, and communicated to the computing system 203 or the data processing system 400 thereof.

In addition to the plate handler 295, the ejection system 202 may include an ejector 290 that ejects droplets from the wells of the well plates. The ejector 290 may be any type of suitable ejector, such as an acoustic ejector, a pneumatic ejector, or other type of contactless ejector. In an example, the plate handler 295 receives a well plate from the sample handler 280. The plate handler 295 transports the plate to a capture location that may be aligned with the capture probe 205. Once in the capture location, the ejector 290 ejects droplets from one or more wells of the well plates. The plate handler 295 may include one or more electro-mechanical devices, such as a translation stage that translates the well plate in an x-y plane to align wells of the well plate with the ejector 290 and/or or the capture probe 205.

The computing system 203 includes computing resources, components, and modules that are operative to perform various functions including but not limited to: communicating with other subsystems, receiving and transmitting electrical signals with other subsystems or components thereof, receiving, responding to, and executing user instructions, performing calculations, processing raw data received from mass analyzer, performing splitting data, performing sample-dataset correlation, generating and analyzing mass spectrometry data, identifying, annotating, and assigning MS peaks of mass spectra, extracting spectral features from mass spectra, conducting library search, identifying analytes, and outputting analytical report to end users.

In some examples, the computing system 203 includes a computing device 210, a controller 235, and a data processing system 400. The computing device 210 may be in the form of electronic signal processors and operative to perform various computing functions. The controller 235 may be in the form of electronic signal processors and in electrical communication with other subsystems within the system 10 or 10′. The controller 235 is further configured to coordinate some or all of the operations of the pluralities of the various components of the system 10 or 10′. The data processing system 400 may include various components and modules operative to process mass spectrometry data and to provide real-time feedback to end users and other subsystems.

In some examples, a network 204 may be operably connected to any one or all of the subsystems or components in the system 10 or 10′. The network 204 is a communication network. In the example, the network 204 is a wireless local area network (WLAN). The network 204 may be any suitable type of network and/or a combination of networks. The network 204 may be wired or wireless and of any communication protocol. The network 204 may include, without limitation, the Internet, a local area network (LAN), a wide area network (WAN), a wireless LAN (WLAN), a mesh network, a virtual private network (VPN), a cellular network, and/or any other network that allows system 204 to operate as described herein.

In some examples, the system 10 or 10′ may further include one or more library/database 206. The database 206 can be a commercial database, or a private database containing analytical information from previously analyzed samples, or a combination of both. The library/database 206 includes chemical knowledge of standard of known compounds stored therein, including but not limited to chemical formula or elemental composition, neutral mass, monoisotopic mass, or mass of internal fragments thereof. In some examples, the computer system 203 is operative to perform a search using the database 206 and/or to compare data produced by the data processing system 400 to the retrieved data from the database 206 (such as molecular mass information or spectral features) to facilitate mass analysis and/or analyte identification.

Also illustrated in FIG. 2 are components of a sample delivery system for use in combination with the mass analysis instrument 200. The sample delivery system includes at least a sample source 270 for supplying a plurality of samples, a sample handler 280 for delivering the plurality of samples to a capture location, and a capture probe 205 for independently capturing one or more samples of the plurality of samples. In some aspects, the sample delivery system may further include a plate handler 295 for locating each sample for the plurality of samples proximate to a capture surface of the capture probe 205 and an ejector 290 for selectively ejecting that located sample into the capture surface of the capture probe.

In operation, a sample delivery system (including sample source 270 and sample handler 280) can iteratively deliver independent samples from a plurality of samples (e.g., a sample from a well of a well plate 75) to the capture probe 205. The capture probe 205 can dilute and transport each such delivered sample to the ion source 115 disposed downstream of the capture probe 205 for ionizing the diluted sample. A mass analyzer 120 can receive generated ions from the ion source 215 for mass analysis. The mass analyzer 120 is operative to selectively separate ions of interest from generated ions received from the ion source 215 and to deliver the ions of interest to an ion detector 226 that generates a mass spectrometer signal indicative of detected ions to the data processing system 400. In some aspects, the separate ions of interest may be indicated in an analysis instruction associated with that sample. In some aspects, the separate ions of interest may be indicated in an analysis instruction identified by an indicia physically associated with the plurality of samples.

In some aspects, the system 10 or 10′ may further include the generation, assignment, and use of identifiers associated with collections of samples and/or individual samples, and incorporation by one or more of components 270, 280, 295, 205, 200, etc. of identifier readers. For instance, an identifier associated with a well plate may be read or scanned by a machine reading device 265 as it leaves the sample source 270 and/or when the well plate is received by the plate handler 295. In such aspects, the identifier(s) may be used by the system to associate a corresponding one or more sets of instructions for use by the mass analysis instrument 200, 120 when analyzing transported sample droplets 108. In some aspects, the identifier may include an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and examples of the present disclosure.

Additional details regarding implementation and operation of system 10 or 10′ in accordance with various aspects and examples of the present disclosure can be explained with reference to the Figures. FIGS. 2 and 3 present system diagrams illustrating examples of a system 10 or 10′, each example including a sample handler 280 and an associated controller 235, which may be, for example, a Biomek computer available from Beckman Coulter Life Sciences, is in operative communication with a mass analysis instrument 200 and a controller for the capture probe 205, which may include, for example, an a SciexOS® computer available from Sciex. The SciexOS® computer includes a control component 227 for the capture probe 205, represented for example by Sciex open port probe (OPP) (also referred to as an open port interface (OPI)) software, and a control component 227 for the mass analysis instrument 200, which may be the Analyst® computer. The mass analysis instrument 200 and capture probe controller 207 may be further in operative communication with an ejector 290 and an X-Y Well Plate Stage 295 and plate handler controller 296, which may be, for example, a liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices.

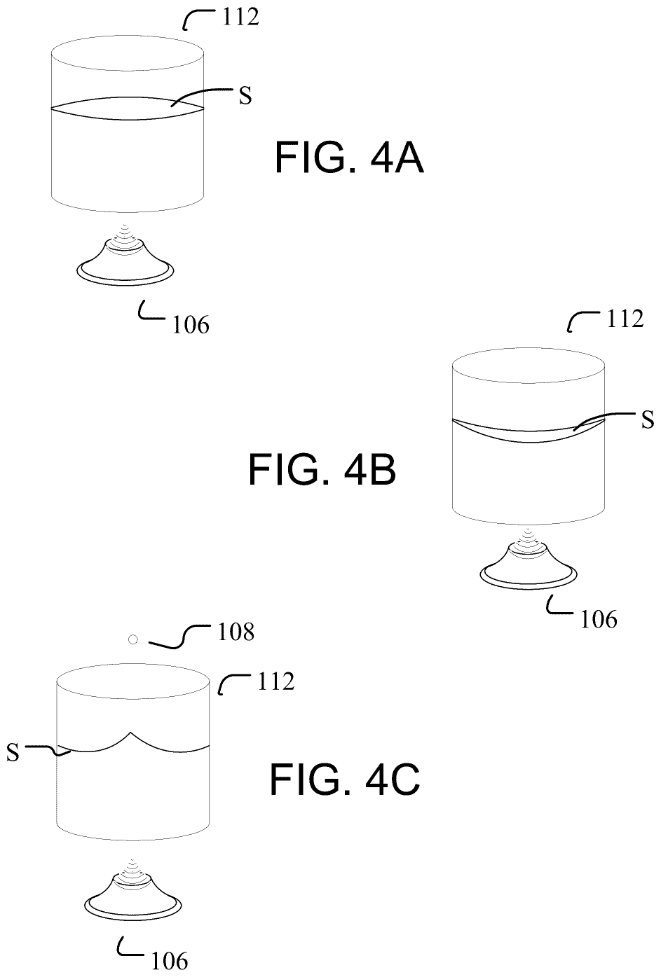

FIGS. 4A, 4B, and 4C depict a sample in three stages of acoustic perturbation. In FIG. 4A, a liquid sample is positioned within reservoir 112 that arranged adjacent to acoustic ejector 106. In FIG. 4A, acoustic ejector 106 is off or operating at very low level.

The surface S of the sample is substantially flat and unperturbed, but for curvature to the surface S caused by the meniscus effect. The amount of the meniscus is based upon surface tension characteristics of the sample, among other factors, and so will vary sample to sample, though in FIG. 4A it is shown as being substantially zero.

FIG. 4B shows the same sample, but with acoustic ejector 106 operating in an analysis mode. In an analysis mode, acoustic ejector 106 is operated at one or more power levels that are below the power level sufficient to cause droplets to be ejected from the sample. It is common for analysis of the sample, such as using DFA, to involve application of increasing power levels of pulses applied by the acoustic ejector 106. With each pulse (or at each power level) the surface S can be characterized by receiving the reflected pulse from the surface S.

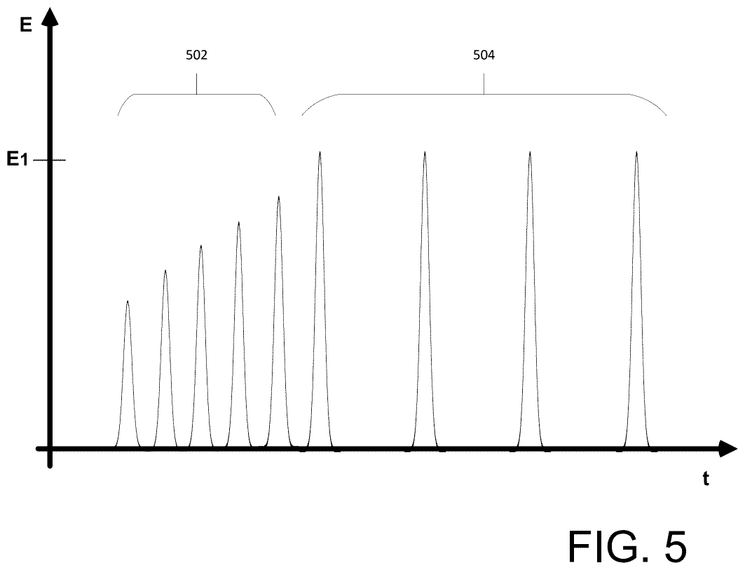

Because reflection will occur at a liquid-gas interface, the reflected surface S can provide information about the meniscus height of the sample in the reservoir 112. At any given level of energy applied, a dimple will form at the center of the sample, causing a change in the distance from acoustic ejector 106 to surface S. By detecting the magnitude of the dimple at a variety of energy levels, and with some prior knowledge of the characteristics of the sample, an ejection energy level can be determined (see E1, FIG. 5, for example).

FIG. 4C shows the same sample located within reservoir 112, but the surface S of the sample has been perturbed sufficiently that a droplet 108 is ejected. In other words, the acoustic ejector 106 is in ejection mode. The energy level applied by acoustic ejector 106 exceeds the energy levels used in analysis mode (FIG. 4B) and are tuned to produce a droplet 108 of a desired size, momentum, and position so that it will be routed through an ADE 102 and OPE 104 for mass spectrometry as described with respect to FIGS. 1-3.

In some systems, analysis mode (FIG. 4B) can be conducted using a standing wave having a certain frequency. In other embodiments, analysis mode (FIG. 4B) can be conducted by providing a series of acoustic energy pulses spaced apart from one another over time. The “cycle” is a term that refers to the amount of time that the analysis is done at a given energy level. Typically there might be between about 10 and about 50 cycles. The repetition rate (or “reprate”) is the frequency of these energy level increases. Duration of analysis is therefore equal to at least the product of the cycle and repetition rate. The goal in most analysis sessions is to determine the “optimized energy level,” or the amount of energy that is determined to be needed to create a droplet with the desired size and momentum. It should be understood that “optimized” is a subjective term, and that there are a number of acceptable solutions for energy level that result in droplets having different sizes and momentums. While “optimized” is a standard term in the art, there is no one correct answer to be determined during analysis mode.

FIG. 5 schematically represents the energy pulses provided during analysis and droplet ejection. As described above, the reprate used during analysis timeframe 502 is different from the reprate used during droplet ejection timeframe 504.

Energy level E₁ is shown, which represents the energy level (“ejection energy level”) of the sample at which the droplet 108 is ejected from the liquid sample in the ADE, as shown in FIG. 4C. As discussed herein, the energy level E₁ can be determined by the reflection from surface S (also shown in FIG. 4C).

At 502, a series of pulses having increasing energy levels are emitted into the sample. As described above with respect to FIG. 4B, in this time domain the energy pulses cause deformation of the surface S that results in different reflected acoustic signal therefrom. Analysis timeframe 502 can last for an indeterminate amount of time, over a number of cycles and based on the reprate of the analysis pulses. During the analysis timeframe 502, reflected pulses can be detected and analyzed to determine the droplet ejection energy level E₁. Once the droplet ejection energy level E₁ is determined, the system can change to droplet ejection timeframe 504.

Generally speaking, AEMS systems are operated as rapidly as possible. Therefore it is common to immediately switch from analysis to droplet ejection (502 to 504). However, it should be understood that in certain contexts there may be reasons to delay switching to droplet ejection timeframe 504.

During droplet ejection timeframe 504, energy pulses are provided at a different and slower reprate than the reprate used in the analysis timeframe 502. Each pulse exceeds the droplet ejection energy level E₁.

The lower reprate during the droplet ejection timeframe 504 is shown graphically by the increased spacing between the pulses in the analysis timeframe 502 relative to the spacing between the pulses in the droplet ejection timeframe 504 in FIG. 5. That is, the distance between pulses along the time axis in FIG. 5 is wider in droplet ejection timeframe 504 than in analysis timeframe 502.

The reason for this increased spacing is that each pulse during droplet ejection timeframe 504 is associated with creation of one or more droplets (see FIG. 4C). As described above, it may be the case that too-frequent droplet creation can exceed the droplet intake capabilities of the OPI, causing inaccurate or incomplete readings or even contaminating other samples or the droplet intake apparatus. While most AEMS systems use a single reprate, decoupling the reprate of the analysis timeframe 502 from that of the droplet ejection timeframe 504, and lowering the latter based on the maximum rate that can be ingested by the OPI, maintains the best speeds for both analysis and droplet ejection.

FIG. 6 shows a wide peak pulse. Each of the pulses in the droplet ejection timeframe 504 could be a wide peak pulse. FIG. 6 illustrates a combined intensity peak, in accordance with various aspects and examples of the present disclosure. In FIG. 6, a chronogram 600 illustrates a plurality of peaks 601, 602 . . . 610 being detected for a number of droplet ejections from the same well such as, e.g., 10 droplet ejections. For example, the droplet ejection frequency may be equal to 10 Hz, so that up to 10 droplet ejections may be performed for each second. As a result, the delay between droplet ejections may be equal to about 0.1 second. As another example, the cycle time, or time to complete a single mass spectrum, is equal to one (1) second. Accordingly, as the first peak 601 is detected as a result of a first droplet ejection, the peak 601 taking one second to complete, another peak 602 is detected about 0.1 s after the start of peak 601, peak 602 being the result of a second droplet ejection and also taking about one second to complete.

In examples, the baseline width of a single peak is illustrated as W1. As additional peaks (not shown) are detected due to subsequent droplet ejections, a tenth peak 610 is also detected as a result of the tenth droplet ejection from the same sample source, e.g., the same sample well of a well plate. In various examples, because the peaks are close to one another, an overall peak 620 may be detected instead of 10 individual peaks, the overall peak 620 being the combination of all ten peaks 601, 602 . . . 610. In other examples, because the droplet ejection frequency is 0.1 s, the width of the overall peak 620, illustrated as baseline width Wn is equal to about 1.9 s for 10 droplet ejections. In other examples, if 20 droplets are ejected, then the width of the overall peak 620 would be equal to 2.9 s. The equation for total time is

$${W}_{n} = {W}_{1} + \frac{n - 1}{reprate}$$

where the reprate in the equation refers to the frequency of droplet ejection.

In addition to the time for droplet ejection defined by the equation above, the entire process for detecting mass and charge using an AEMS system also includes the analysis time. If the reprate in the equation above is lowered to cause lower flow rates into the OPI, then lowering the analysis reprate of the analysis phase will lead to higher total sample characterization time, which is undesirable.

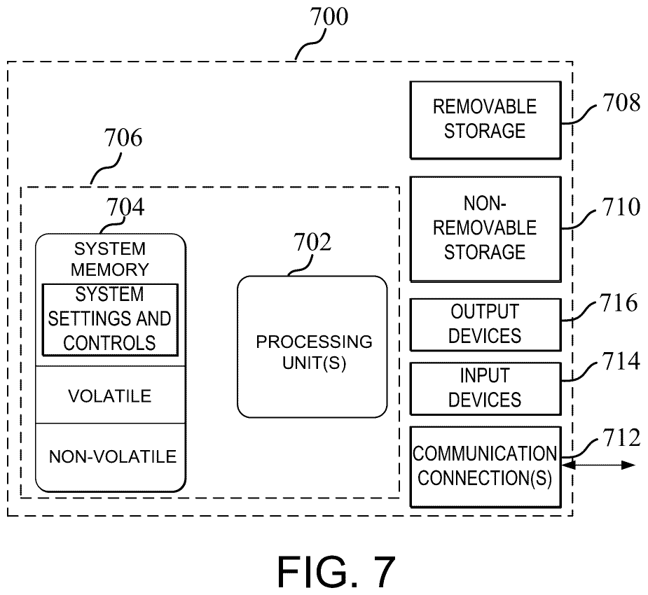

FIG. 7 depicts one example of a suitable operating environment 700 in which one or more of the present examples can be implemented. This operating environment may be incorporated directly into the controller for a mass spectrometry system, e.g., such as the controller depicted in FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 700 typically includes at least one processing unit 702 and memory 704. Depending on the exact configuration and type of computing device, memory 704 (storing, among other things, instructions to control the eject the samples, move the stage, or perform other methods disclosed herein) can be volatile (such as RAM), non-volatile (such as ROM, flash memory, etc.), or some combination of the two. This most basic configuration is illustrated in FIG. 7 by dashed line 706. Further, environment 700 can also include storage devices (removable, 708, and/or non-removable, 710) including, but not limited to, magnetic or optical disks or tape. Similarly, environment 700 can also have input device(s) 714 such as touch screens, keyboard, mouse, pen, voice input, etc., and/or output device(s) 716 such as a display, speakers, printer, etc. Also included in the environment can be one or more communication connections 712, such as LAN, WAN, point to point, Bluetooth, RF, etc.

Operating environment 700 typically includes at least some form of computer readable media. Computer readable media can be any available media that can be accessed by processing unit 702 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 700 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 700 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 700 is part of a network that stores data in remote storage media for use by the computer system 700.

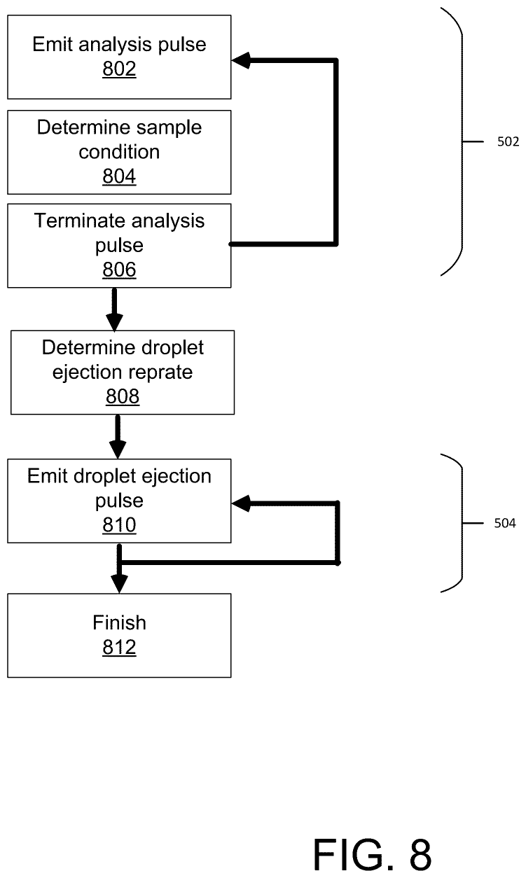

FIG. 8 shows a method for acoustic dispensing of a train of droplets from a sample in a well as described above. The two halves of the method correspond to analysis timeframe 502 and droplet ejection timeframe 504, as described above with respect to FIG. 5.

In analysis timeframe 502, an analysis pulse is emitted at 802. At 804, the reflected wave is analyzed, wherein the reflected pulse is based upon one of the plurality of analysis pulses after reflection at the sample at 802. The analysis pulse is terminated at 806.

The method repeats with further emissions 802, determinations, and terminations 806 for the analysis timeframe 502. This repetition occurs at the analysis repetition rate. Once analysis is complete, based at least in part on the signal indicative of the condition of the sample, a droplet ejection repetition rate can be determined at 808.

The droplet ejection repetition rate can be based upon characteristics of the sample, the overall system and maximum ingestion rate for droplets, desired sample plug size, or other factors. It should be understood that in some circumstance, the droplet ejection rate can be determined before or concurrently with the analysis timeframe 502. FIG. 8 shows the determination 808 after analysis, as the condition of the sample may provide some information that is useful in determining the appropriate droplet ejection repetition rate at 808, but in some cases that information may not be necessary or helpful in setting the ejection repetition rate.

At 810, the method enters the droplet ejection timeframe 504. At 810, a droplet ejection pulse is emitted as described above with respect to FIG. 4C. Droplet ejection pulse emission at 810 is repeated at the droplet ejection repetition rate determined at 808 until the desired sample quantity has been produced, at which point the method finishes at 812.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method for acoustic dispensing of a train of droplets from a sample in a well, the method comprising:
emitting a plurality of analysis pulses at an analysis repetition rate into the sample;
determining a condition of the sample based upon a reflected pulse, wherein the reflected pulse is based upon one of the plurality of analysis pulses after reflection at the sample;
determining a droplet ejection repetition rate based upon a preselected rate; and
emitting an acoustic ejection signal into the sample at the droplet ejection repetition rate that is lower than the analysis repetition rate.

2. The method of claim 1, wherein the acoustic ejection signal is emitted in a wide peak mode wherein each acoustic ejection signal is emitted over a sufficiently long signal duration for a plurality of ions to be produced.

3. The method of claim 1, further comprising:
presenting a user with one or more droplet ejection repetition rate options;
receiving a selected droplet ejection rep rate; and
applying the selected droplet ejection rep rate as the preselected droplet ejection repetition rate.

4. The method of claim 1, wherein the analysis repetition rate is in a range of 80 Hz and 240 Hz and the ejection repetition rate is less than 80 Hz.

5. The method of claim 1, wherein the analysis repetition rate is in a range from 10 Hz to 100 KHz.

6. The method of claim 5, wherein the ejection repetition rate is in a range of 5 Hz to 15 Hz.

7. The method of claim 6, wherein the ejection repetition rate is equal to about 10 Hz.

8. The method of claim 1, further comprising: terminating based at least in part on a signal indicative of the condition of the sample.

9. A system for delivering a sample from a well, the system comprising:
an acoustic transducer;
an input device;
a processor operatively coupled to the acoustic transducer and the input device; and
a memory coupled to the processor, the memory storing instructions that, when executed by the processor, cause the processor to:
perform, via the acoustic transducer, an analysis of the sample in the well at an analysis repetition rate to determine a condition of the sample;
receive, at the input device, a droplet ejection repetition rate; and
eject, via the acoustic transducer, the droplet at the received droplet ejection repetition rate;
wherein the analysis repetition rate is higher than the ejection repetition rate.

10. The system of claim 9, wherein to eject the droplet at the received droplet ejection repetition rate comprises to emit acoustic pulses corresponding to a wide peak mode setting.

11. The system of claim 9, further comprising a user interface configured to:
present a user with one or more droplet ejection repetition rate options;
receive a selected droplet ejection rep rate; and
apply, via the processor, the selected droplet ejection rep rate as the preselected droplet ejection repetition rate.

12. The system of claim 9, wherein the analysis repetition rate is in a range of 10 Hz and 100 KHz.

13. The system of claim 12, wherein the ejection repetition rate is less than 80 Hz.

14. The system of claim 9, wherein the analysis repetition rate is equal to about 160 Hz.

15. The system of claim 13, wherein the ejection repetition rate is in a range of 5 Hz and 15 Hz.

16. The system of claim 15, wherein the ejection repetition rate is equal to about 10 Hz.

17. The system of claim 9, wherein the memory storing instructions further cause the processor to: terminate based at least in part on the determined condition of the sample.
